(19) United States
(12) Patent Application Publication
(10) Pub. No.: US 2024/0027285 A1
(43) Pub. Date: Jan. 25, 2024

(54) System for Monitoring Temperature of Bearings

(71) Applicant: Metrologics, LLC, Katy, TX (US)

(72) Inventor: Fred Wenzel, Katy, TX (US)

(21) Appl. No.: 18/353,871

(22) Filed: Jul. 17, 2023

Related U.S. Application Data
(60) Provisional application No. 63/390,465, filed on Jul. 19, 2022.

(51) Int. Cl. G01K 13/08; F16C 17/24

(52) U.S. Cl. CPC G01K 13/08; F16C 17/243; F16C 2233/00; G01K 2205/00

(57) ABSTRACT

A system for measuring the temperature of connecting rod bearings within a crankshaft or other piston driven system. The system having at least one temperature sensing module mounted in a connecting rod bearing end cap. The temperature sensing module transmits the temperature data via radio or RFID to a data management module mounted outside the crankcase or other housing. The data management module processes the data and alerts users to any temperatures outside an acceptable range.

### CROSS REFERENCE TO RELATED APPLICATION

This application claims priority to U.S. Application No. 63/390,465 filed on Jul. 19, 2022, the disclosure of which is incorporated herein by reference for all purposes.

### FIELD OF THE INVENTION

The present invention relates to monitoring the temperature of bearings and, more particularly, to monitoring the temperature of a bearing of a crankshaft connecting rod while the crankshaft and connecting rod are moving.

### BACKGROUND OF THE INVENTION

It is important to know the working environment of a bearing assembly, particularly with respect to the temperature. Knowing the expected temperature of a particular application/environment allows for the selection of proper bearing materials, grease types, bearing clearance, and fit. In high temperatures, lubricant/grease viscosity is reduced which significantly reduces the life of the lubricant/grease. During use, temperature increase can cause components to expand and change the fit, wear, and internal clearance of the components.

While knowing the expected temperature of the bearing working environment is important when first assembling a system, it is also important to monitor the temperature over time as the system is used. As bearings lose lubricant they can overheat, break, and damage multiple components in the system. Detecting an increase in bearing temperature is key to avoiding catastrophic failures.

On a rotating crankshaft, there are main bearings which are fixed. The temperatures of these are typically measured with bolt on thermocouples. There are also rod bearings which are positioned in connecting rods that push compression pistons. Thermocouples cannot be bolted to these rod bearings as the crankshaft around which they are affixed can be rotating at up to 1800 rpm. Additionally, measuring the temperature of the rod bearings from a distance is difficult due to splashing oil in the crankcase. Accordingly, there is a need for a way to measure the temperature of rotating rod bearings.

### SUMMARY OF THE INVENTION

In one aspect, the present invention relates to a system for monitoring the temperature of connecting rod bearings while the connecting rod is rotating.

In another aspect, the present invention relates to a system for tracking the temperature of connecting rod bearings while the connecting rod is rotating and alerting users to a temperature outside of specifications.

In yet another aspect, the present invention relates to a self-powered system for monitoring the temperature of rod bearings.

These and further features and advantages of the present invention will become apparent from the following detailed description, wherein reference is made to the figures in the accompanying drawings.

### BRIEF DESCRIPTION OF THE DRAWINGS

FIG. 1 is a prior art image of a connecting rod.

FIG. 2 is an image of a connecting rod with the temperature sensing module of the present invention mounted therein.

FIG. 3 is a schematic of one embodiment of the temperature sensing module of the present invention.

FIG. 4. is a schematic of one embodiment of the data management module of the present invention.

FIG. 5 schematically depicts one embodiment of the system of the present invention.

### DETAILED DESCRIPTION OF PREFERRED EMBODIMENTS

Embodiments of the invention are described more fully hereafter with reference to the accompanying drawings. Elements that are identified using the same or similar reference characters refer to the same or similar elements. The various embodiments of the invention may, however, be embodied in many different forms and should not be construed as limited to the embodiments set forth herein. Rather, these embodiments are provided so that this disclosure will be thorough and complete, and will fully convey the scope of the invention to those skilled in the art.

The system will be described herein with respect to a natural gas compressor which includes a crankshaft assembly. It will be understood though that the invention is not so limited and can be used in any system which incorporates piston compression systems driven by crankshafts or the like.

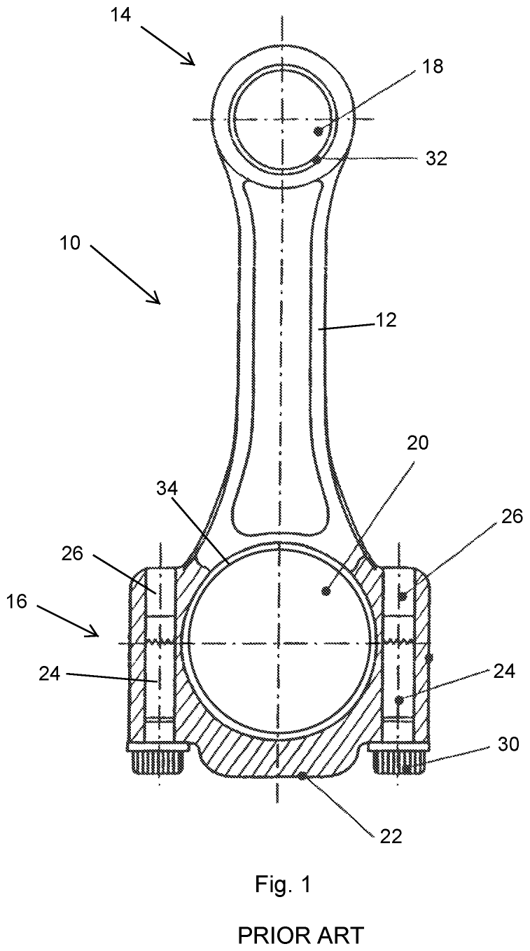

Turning first to FIG. 1 there is shown generally as 10 a prior art example of a connecting rod from a crankshaft assembly. Connecting rod 10 includes body 12 having first and second ends 14 and 16, respectively. Small and large connecting rod eyes 18 and 20, respectively, are formed at ends 14 and 16, respectively. Rod cap 22 is attached to end 16 of body 12 and helps form eye 20. Pairs of bolt holes 24 and 26 extend through rod cap 22 and lateral formations 28 on body 12. Bolts 30 extend through the bolt holes to hold rod cap 22 in place. Bushing 32 is positioned in eye 18. A connecting rod bearing 34 is positioned in eye 20. A connecting rod bearing typically comprises two semicircular components which form a single bearing. These rod bearings 34 will surround the crankshaft (not shown).

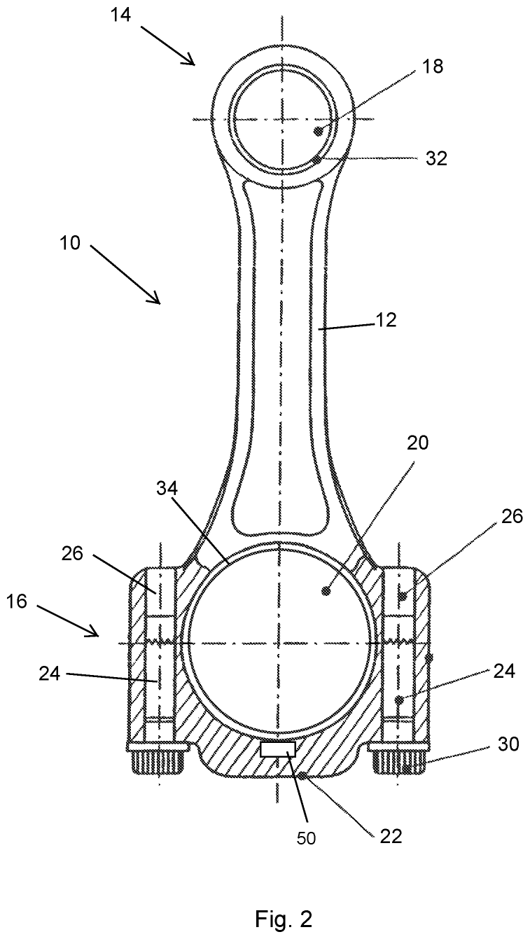

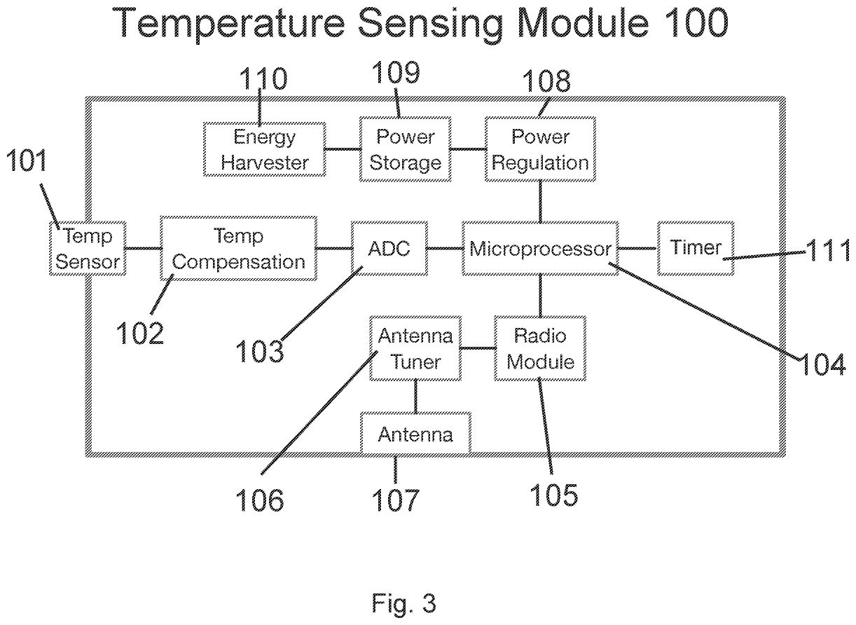

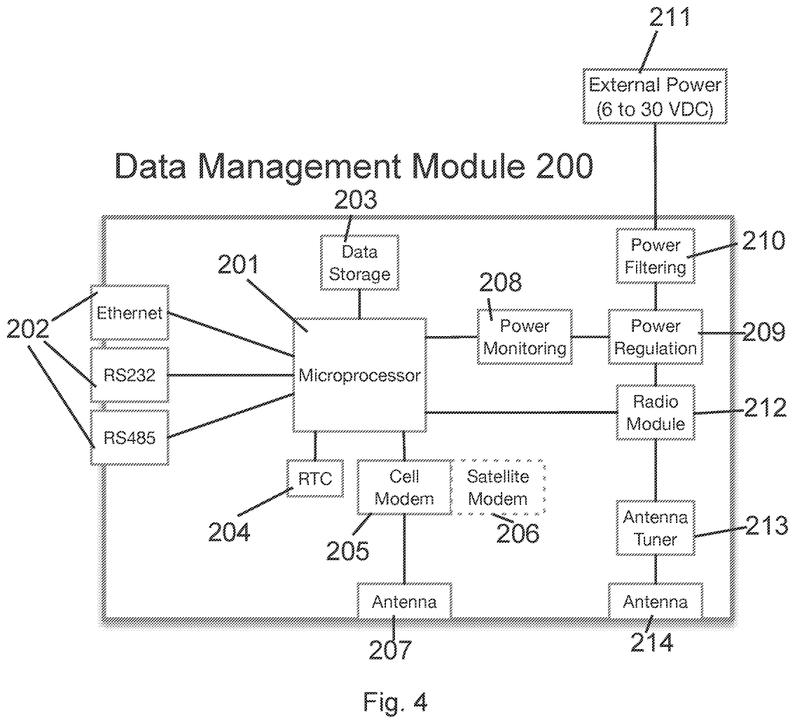

Turning to the system of the present invention, as shown in FIGS. 3 and 4, the system comprises two types of modules: the temperature sensing module 100 and the data management module 200. The temperature sensing module 100 utilizes a printed circuit board (PCB) with a temperature sensing element 101, e.g., a thermocouple, resistance temperature detector (RTD), or thermistor. The temperature sensing element 101 can measure temperatures from 0° F. to 300° F. As shown in FIG. 2, the PCB is mounted in a metal housing 50 which is installed into the rod bearing cap 22 of a connecting rod. It will be appreciated that the exact size and position of housing 50 can vary depending on the connecting rod in question. The module is placed such that the temperature sensing element can detect the temperature of the rod bearing of that connecting rod. In a preferred embodiment, the temperature sensing element is a thermocouple.

The PCB also includes a microprocessor 104, a radio transmitter/transceiver 105, and a timer or real time clock 111. The temperature sensing module 100 is configured to remain in sleep or idle mode for a desired time period. It periodically wakes up and takes a reading of the bearing temperature. The temperature sensing module transmits the temperature reading data to the data management module. The system can be programmed to transfer after each individual reading or only transfer data after a certain number of readings or certain amount of time. The temperature data is transmitted to the data management module via radio or RFID. Accordingly the temperature sensing module includes an antenna tuner 106 and an antenna 107 for sending the data.

In a preferred embodiment temperature sensing module 100 also includes a temperature compensation circuit 102 which helps ensure the PCB can continue to operate under high temperature conditions.

It will be appreciated that the temperature sensing module may include additional components, e.g., analog to digital converter 103, well known to those skilled in the art and required for the operation thereof. Such components are commonplace and not described in detail herein.

The temperature sensing module may be battery powered. In a preferred embodiment, the temperature sensing module is a thermocouple with an energy harvester 110 to power it. The energy harvester 110 converts the vibration of the machine when in operation to a voltage/current output which is then stored in a super capacitor 109 or other power storage component. This stored power is then sent through a power regulator 108 to power the temperature sensing module, thus negating the need for a batter power source.

The data management module 200 of the system receives the data from the temperature sensing module 100, processes it, and determines if any alerts/alarms are required. The data management module 200 includes a microprocessor 201 a data storage circuit 203, a real time clock 204, a radio module, 212, an antenna tuner 213 and an antenna or transceiver 214 for receiving temperature data from one or more temperature sensing modules 100, and one or more connections and transmitters for sending the data to remote locations. The data can be transmitted in a variety of ways. To that end, data management module 200 may include one or more hardline connections/ports 202 (e.g., Ethernet, RS232, or RS485 ports), a cell modem 205, a satellite modem 206, and/or an antenna 207.

In a preferred embodiment, data management module 200 also includes power monitoring 208, power regulation, 209, and power filtering 210 circuits to optimize the power usage. Data management module 200 can be connected to an external power source 211.

The data management module 200 of the system is mounted within a housing or enclosure (not shown) outside the compressor casing (not shown) and is screwed into an existing threaded access port in the compressor casing. The antenna 214 extends slightly into the compressor case to improve reception of radio signals from the temperature sensing module(s) 100.

The data management module 200 is configured to receive data from one or more temperature sensing modules 100. It will be appreciated that typical crankshaft systems include multiple compression pistons and multiple connecting rods with connecting rod bearings. Each connecting rod bearing in a crankshaft system can have a respective temperature sensing module 100 installed. But only a single data management module 200 is required for a single crankshaft system.

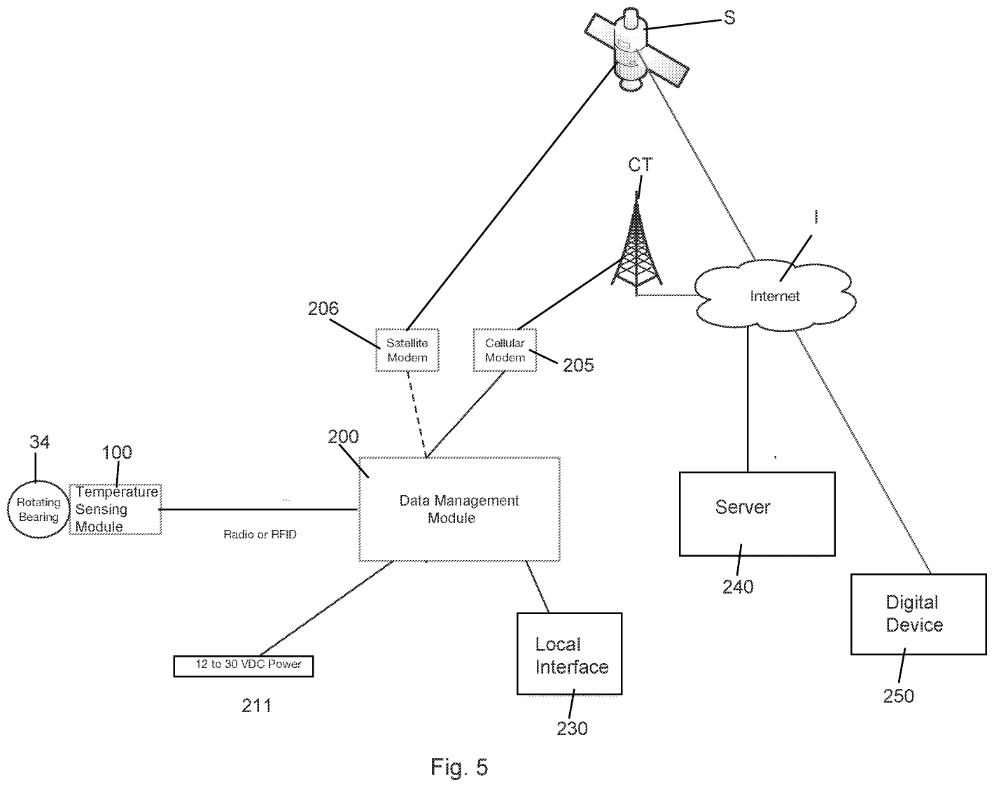

The data management module 200 receives the transmitted temperature data from the temperature sensing module(s) 100, processes it and determines if an exception from normal operating conditions is present. As shown in FIG. 5, the data is stored at 203 and then sent to a local interface 230 or a remote device at desired time intervals. If a temperature is measured which is outside a preprogrammed acceptable range or which crosses a pre-programmed threshold, the data management module 200 will send an alert/alarm to the remote device. The remote device can comprise one or more computer servers 240 or other digital devices 250 (e.g., computers, tablets, mobile phones, and the like) used in the industry for monitoring or controlling operations. The alert/alarm may be in the form of a text message, email, voice message, visual notification (e.g., flashing light), and/or audible alarm. The data management module 200 can communicate with the remote device via wired or wireless connections well known to those skilled in the art. Thus, as shown in FIG. 5, the data may be sent via cellular modem 205 to a cell tower CT, or via satellite modem 206 to satellite S. The data is then sent from cell tower CT or satellite S via the Internet to a server 240 or digital device 250.

The system of the present invention provides wireless real time temperature measurement of rod bearings of any system with pistons. It also provides immediate notification of abnormal conditions in the bearing that result in temperature increases which could lead to bearing and equipment failure. This advance notice reduces maintenance costs and equipment losses, as well as improving the safety of the overall system. The system of the present invention can be retrofit onto existing systems.

Although specific embodiments of the invention have been described herein in some detail, this has been done solely for the purposes of explaining the various aspects of the invention and is not intended to limit the scope of the invention as defined in the claims which follow. Those skilled in the art will understand that the embodiment shown and described is exemplary, and various other substitutions, alterations and modifications, including but not limited to those design alternatives specifically discussed herein, may be made in the practice of the invention without departing from its scope.

What is claimed is:

1. In a system which comprises pistons driven by connecting rods, each connecting rod having a respective connecting rod bearing, the system disposed within a housing, an improvement comprising:
one or more temperature sensing modules mounted in a respective connecting rod to measure the temperature of the respective connecting rod bearing, wherein said temperature sensing module comprises:
a thermocouple operative to measure the temperature of the connecting rod bearing and generate a data point indicative of the temperature;
a microprocessor operative to save the temperature data point;
a transmitter operative to transmit the temperature data point;
a data management module mounted on an exterior surface of the housing and comprising:
a receiver operative to receive the data point from the temperature sensing module;
a microprocessor operative to compare the temperature data point to a predetermined acceptable range and to generate an alarm if said temperature data point is outside the acceptable range;
a wired or wireless connection for sending the data point and/or an alarm to a remote device.

2. The system of claim 1, wherein said temperature sensing module harvests energy for power.

3. The system of claim 1, wherein said temperature sensing module further comprises a timer or real time clock.

4. The system of claim 1, wherein said connection is a wireless connection comprising a cellular modem or a satellite modem.
